(19) United States
(12) Patent Application Publication
(10) Pub. No.: US 2023/0368273 A1
(43) Pub. Date: Nov. 16, 2023

(54) REMOTE KIOSK ACCESS SYSTEM

(71) Applicant: Kodak Alaris Inc., Rochester, NY (US)

(72) Inventors: Scott C. Robinson, Rochester, NY (US); Joseph A. Manico, Rochester, NY (US)

(73) Assignee: Kodak Alaris Inc., Rochester, NY (US)

(21) Appl. No.: 18/198,117

(22) Filed: May 16, 2023

Related U.S. Application Data
(60) Provisional application No. 63/342,555, filed on May 16, 2022.

(51) Int. Cl. G06Q 30/0601; G06Q 10/083; G06Q 20/12; H04L 51/02

(52) U.S. Cl. CPC G06Q 30/0635; G06Q 10/083; G06Q 20/12; H04L 51/02

(57) ABSTRACT

A method of providing photofinishing services to a user including choices of photofinishing services, retailers, retail locations, delivery, and payment options, using a computer processor, communications network, and user interface. The user can send one or more digital images to the selected retailer and retail location via the communications network. Once the user selects the type and amount of photo products to be made from the provided digital images, the user can select any additional retail products, selects a delivery means, and payment option. The processor can coordinate the communications for production of the photofinishing order, billing, and any other retail purchase selected by the user. The processor also communicates the additional retail items to the retail staff and/or personal shopper and coordinates the production of the photofinishing order.

### CROSS-REFERENCE TO RELATED APPLICATIONS

This application is a non-provisional of and claims priority to U.S. provisional application No. 63/342,555, filed on May 16, 2022. All publications, patents, patent applications, databases and other references cited in this application, all related applications referenced herein, and all references cited therein, are incorporated by reference in their entirety as if restated here in full and as if each individual publication, patent, patent application, database or other reference were specifically and individually indicated to be incorporated by reference.

### BACKGROUND OF THE INVENTION

The present disclosure relates to remote kiosk access systems that are capable of receiving, processing, and facilitating fulfillment of commercial orders for photofinishing services and other retail items. Embodiments described herein relate to kiosk access systems for customers, kiosk managers, and third-party delivery services for photofinishing service ordering and delivery.

Traditionally, photo services have required in-store ordering, production, and pickup, leading to a number of issues. Queuing at single line photo kiosks can be an issue when multiple customers arrive at the same time. This problem can be magnified when due to the seasonal nature of photo print product demand resulting in long queue times related to a seasonal event. Coordinating order processing and pickup with other items during shopping can lead to additional issues, especially where customers are seeking to obtain photo print products while shopping for perishable goods such as groceries. Specialized print items can result in additional time to receive an order due to potential employee intervention to produce and assemble the order.

While personal shoppers or “Buy Online, Pickup In Store” (“BOPIS”) systems have been found effective for other types of merchandise, integration with photo pickup has been limited. Privacy concerns can prevent users from wishing to integrate photo orders into larger, non-photo orders due to the number of people with access to the merchandise before delivery. Additionally, integration between photo ordering and BOPIS or personal shopper systems have been limited. Therefore, there is a need in the art for a method for remote ordering of photo products that can be integrated with personal shoppers and BOPIS systems that preserve the privacy of the customer.

### SUMMARY OF THE INVENTION

Described herein are embodiments of a remote kiosk access system for ordering photos. In certain embodiments, the remote kiosk access system can allow for the remote order of printed photos or photo merchandise. Embodiments can be configured to work with home delivery, personal shoppers, or BOPIS ordering systems. This can allow for photo product orders to be included in orders for other consumer goods.

Photo kiosk embodiments of the present invention can be configured to receive the remote orders and queue order production based on different factors. Photo kiosks can be designed for a variety of operating conditions due to volatile operating conditions associated with BOPIS and personal shopper access. Certain embodiments include protective barriers to protect components and products when not in use. Certain embodiments can produce orders such that the privacy of the customer is protected in circumstances where a personal shopper or BOPIS employee picks up the order.

The remote kiosk access system embodiments described herein can be configured to provide access to the kiosk to pick up orders when ready. A configuration can be used to indicate when an order is ready with instructions on how to pick up the order. Another configuration can allow customers access to lockers associated with the kiosk for order pickup. The system can also allow personal shopper and BOPIS access to the kiosk to pick up orders for delivery to the customer.

### BRIEF DESCRIPTION OF THE DRAWINGS

The present technology will be better understood upon reading the following detailed description of non-limiting embodiments and examining the accompanying drawings, which are summarized as follows.

FIG. 1 depicts a method of placing a remote photo order according to an embodiment of the technology.

FIG. 2 depicts a method of placing a remote photo order as a part of a personal shopper or BOPIS order according to an embodiment of the technology.

FIG. 3 depicts a photo banding device according to an embodiment of the technology.

FIG. 4 depicts a privacy protected band of photos according to an embodiment of the technology.

FIG. 5 depicts a method of receiving a remote photo order as a part of a BOPIS order according to an embodiment of the technology.

FIG. 6 depicts a method of receiving a remote photo order as a part of a personal shopper delivery order according to an embodiment of the technology.

### DETAILED DESCRIPTION

Aspects, features, and advantages of the present technology will be further appreciated when considered with reference to the following description of embodiments and accompanying drawings. In describing embodiments of the technology, including particular embodiments illustrated in the drawings, specific terminology will be used for the sake of clarity. The embodiments of the present technology, however, are not intended to be limited to the specific terms used, and it is to be understood that each specific term can include equivalents that operate in a similar manner to accomplish a similar purpose. To the extent features of the present technology are depicted in the drawings in different embodiments, it should be understood that features from different embodiments can be combined to achieve the full functionality described herein unless expressly disclaimed otherwise.

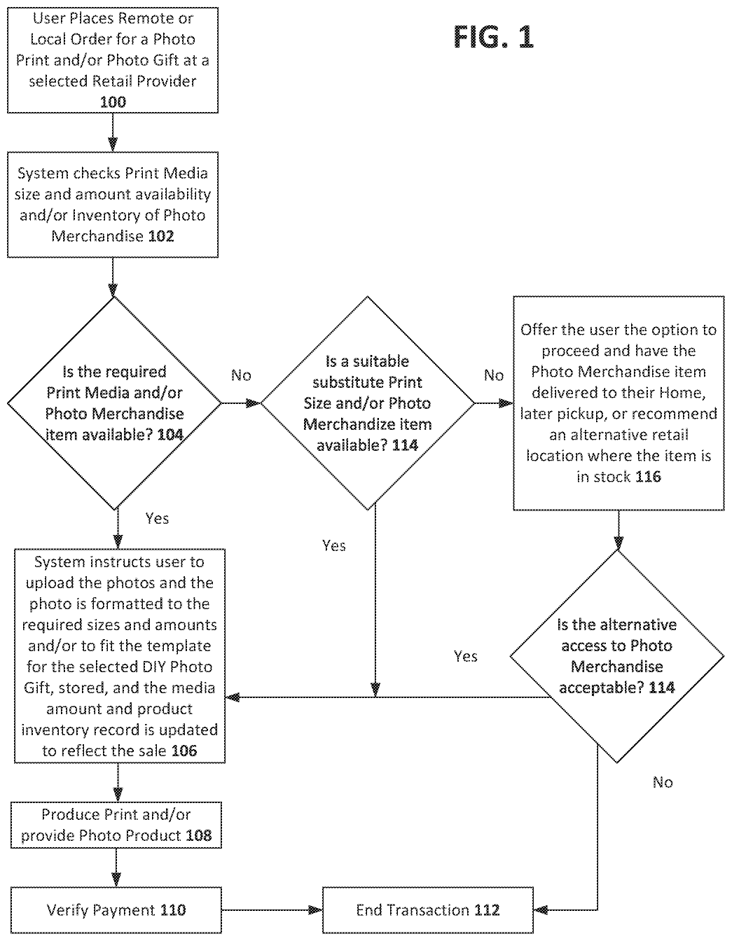

FIG. 1 depicts a method of placing a remote photo product order according to an embodiment of the technology. The order can be placed on a smartphone, computer, or any other networked computational device. Additionally, the kiosk may include a processor and display for placing orders locally.

A customer can first place the remote or local order in step 100. Embodiments of ordered products can include photo prints, photo products, framed photographs, photo albums, photo mugs, photo apparel, or virtual photo products stored on portable memory device or delivered via a network. The kiosk processor can then check the availability and inventory of print media and photo merchandise for the products ordered in step 102. The inventory can be compared against the order by the processor in step 104. If there is sufficient inventory the processor can proceed to step 106. Here, the processor can instruct the user to upload the photos. The photos can be edited and formatted as appropriate for the various photo merchandise and products being purchased. The inventory of the kiosk can further be updated to reflect the purchase of the print media and/or photo merchandise. The kiosk can then produce the prints and/or photo merchandise in step 108 and verify payment for the products in step 110 prior to ending the transaction in step 112. Order and payment confirmation can be provided to the customer based on their preferences, for example, by phone or by e-mail.

In the event that the kiosk does not have the required print media and/or photo merchandise in step 104, the processor can ask the customer if there is a suitable substitute print size or photo merchandise in step 114. If there is a suitable alternative, the processor can proceed to step 106 for photo uploading and formatting. If not, the processor can proceed to step 116 where the processor can offer alternative production and delivery options for the originally selected products. These alternatives can include direct home delivery of the products through the mail or package delivery services, a later pickup time or date after restocking has occurred of the required products, and/or an alternative retail location with sufficient stock of the identified products. Home delivery options can also include autonomous and/or remotely piloted terrestrial or aerial delivery drones. The processor can check with the customer to determine if the given alternatives are acceptable in step 118. If it is acceptable, the processor can proceed to step 106 for photo uploading and formatting. The photofinishing order can then be forwarded to another associated retailer or local photofinishing hub for production of the order if that alternative is selected. Additionally, the order can also be forwarded to a local finishing hub when the order requires additional finishing steps not provided by the retail location. If it is not acceptable, the processor can end the transaction at step 112.

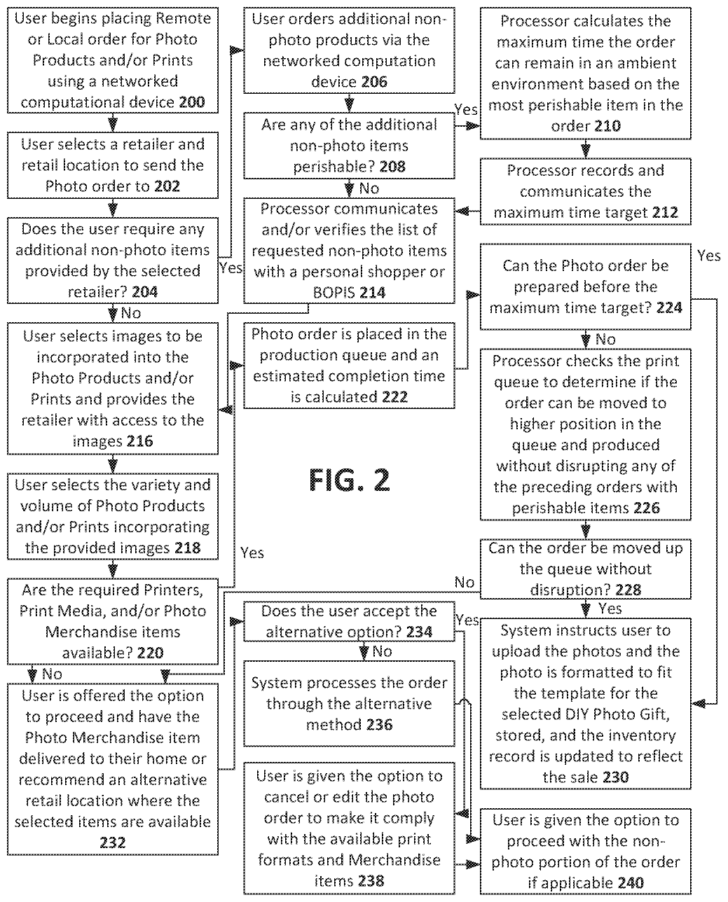

FIG. 2 depicts a method of placing a remote order as a part of a BOPIS or personal shopper delivery order. The personal shopper can be a private contractor and/or affiliated with a third-party service provider. A customer can first begin by placing the order and selecting a retailer and location in steps 200 and 202. The customer can select a delivery method at this time. Delivery methods can include pickup inside the store, curbside delivery at the store, via a drive through pickup window, home delivery, and/or to a selected recipient. The system can then check whether the user requires any additional non-photo items in step 204. If the user requires additional non-photo items, the items can then be ordered through the same system and device as in step 206. As a part of ordering non-photo items, the system can check to see if any of the items are perishable in step 208. If perishable items exist, the processor can calculate and record the maximum amount of time the perishable items can be at ambient temperature in step 210 and communicates this maximum time target in step 212. The system can then verify the list of non-photo items with the personal shopper or BOPIS in step 214.

The processor can further be configured to allow the user to select and upload images after selection of other non-photo products at step 216. The images can be shared where the retail store for creating the photo products. The user can then select the photo products and/or prints at step 218. The processor can then check to ensure that the print media and/or merchandise is available at the previously selected retail location in step 220.

If media and merchandise is available, the order can be placed in a production queue with an estimated completion time at step 222. This production queue time can then be compared against perishable item time determined in steps 210 and 212. The processor can then determine whether the photo order can be completed within the perishable item time in step 224. If it cannot be completed in time, the processor can check to see if the order can be moved to a higher position within the print queue in step 226. This can compare the current order with previous orders to determine if the order can be moved up without disrupting previously made orders with perishable items. The processor can then determine whether the order can be moved up in step 228. If this is the case, the photo order can be processed in step 230 such that the photos are uploaded, and inventory is updated to reflect the sale. The billing for the photo order can be separate from the bill for the non-photo items.

If the order cannot be moved up, or if inventory is not available, the processor can offer alternative options in step 232. The alternatives can include home delivery, a later time or date of order pickup, or an alternative retail location. The alternative option can be presented in step 234. If the alternative is selected the photo portion of the order can be processed through the alternative option in step 236. If the alternative is not selected, the customer can be given the option to cancel or edit the photo order so that is compatible with the available print formats, merchandise, and timing constraints in step 238. In either circumstance the user is given the option to proceed with the non-photo portion of the order if applicable in step 240.

The ordering system can be integrated with BOPIS and personal shopper ordering systems. This can allow cross promotions with the BOPIS or personal shopper ordering systems. The ordering system can use a “chatbot” graphical user interface for configuring orders. The chatbot can provide for the selection of a retail location and checklist of common items available for purchase. The chatbot can be configured with a search function for items not presented. The chatbot can be further configured to provide digital photo upload, editing, and order processing. The chatbot can be configured to collaborate between the customer, kiosk, and BOPIS/personal shopper to coordinate orders.

The ordering system can be configured to display reminders or notifications to the customer. Notifications can be sent via a text, email, and/or phone call and can include the estimated delivery time and location. Notifications can also remind customers of processed orders ready for pick-up. After a predetermined timespan, the ordering system may offer a home delivery option for orders that have not been picked up.

The ordering system can further include a gift mode for ordering. When ordering a product as a gift, the ordering system can include a wrapping or packaging step in the order creation. The order can also be routed to the kiosk nearest the recipient instead of the choice of the customer. This can allow third-party gift delivery of photo products and/or merchandise as a gift.

The kiosk receiving the orders can be configured for in-store pickup, BOPIS, and personal shopper options. The kiosk can comprise a processor and communications device for sending and receiving instructions from the customer. The communication device can communicate by a wired connection, wireless cellular, or Wi-Fi modem. The kiosk can be configured to connect to the internet through the retailer's network connection. The kiosk can be on a movable cart to accommodate various workflows due to seasonal changes, promotions, inventory, and staffing conditions. The kiosk can be configured to work in different work environments. These can include service areas, warehouses, inventory marshaling areas, and retail floors. This can expose the kiosk to a broad range of ambient temperatures and humidity conditions. The kiosk can be made of material suitable for this broad range of operating environments. The kiosk can be modular such that it can be configured to accommodate multiple output device and printer types.

The kiosk can be configured with doors, covers, or roller shutters. This can prevent access to the components of the kiosk when not in use and protect components from ambient conditions. The kiosk can be further configured with lockers or other storage compartments. The lockers can be configured to be only be accessible by an authorized person such as a customer or BOPIS/personal shopper. The lockers can store completed orders for pickup. The kiosk can further include additional storage area for accumulated print and product orders that are not set for immediate pickup or don't fit in storage lockers.

The kiosk can be maintained by the retail staff, personal shopper, photo kiosk provider, and/or third-party service provider. This can include performing media resupply, routine service, error correction, software updates, product updates, and promotional updates for the kiosk.

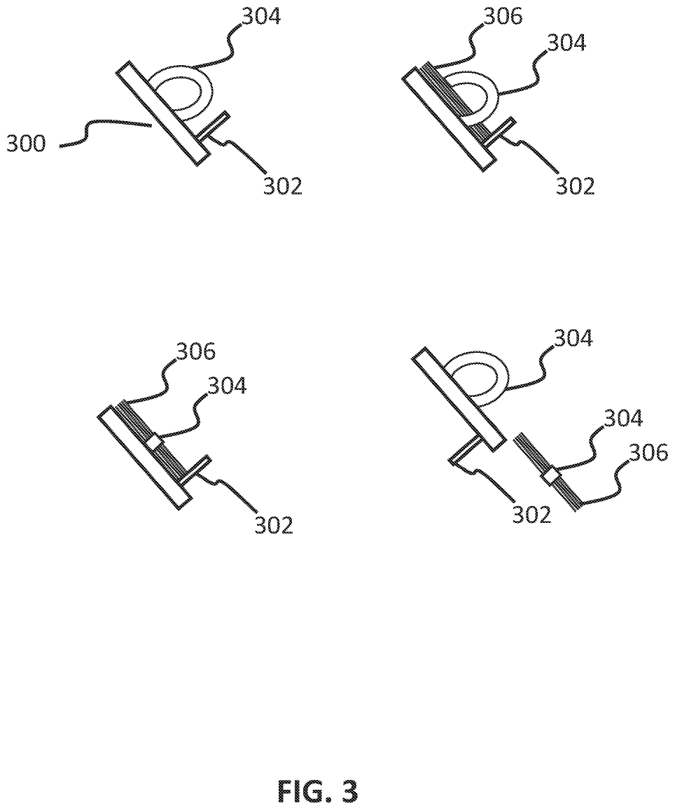

The kiosk can include a photo banding machine as depicted in FIG. 3. The photo banding machine or any other appropriate packaging method can be integrated into the kiosk. The photo banding machine 300 can be initially be set in a position ready to receive photos as shown in the upper left image. In this position, the stop 302 can be in a blocked position and a band 304 can be positioned extending from the banding machine 300. The band 304 can be a paper or plastic band with heat or pressure sensitive adhesive. The bands 304 can further be pre-printed with retail information and human and/or machine readable sequential or random numbers for order processing and tracking.

Photos 306 can then be generated and positioned such that the band 304 can be positioned around the photos 306 as shown in the upper left image. The stop 302 can prevent the photos from bypassing the banding machine 300. Once all the photos 306 have been collected in the banding machine 300 the band 304 can be tightened and sealed around the photos 306 as shown in the lower left image. This can prevent moving the photos 306 until the band 304 is broken. Once banded, the photos 306 can be released by the stop 302 as shown in the lower right image. The stop 302 can then extend and a new band 304 can be prepared for the next photo order. The completed photo order can be placed into a locker or other secure location for pick-up. Alternatively, the photos 306 can be secured with shrink wrap, envelopes, or rubber bands.

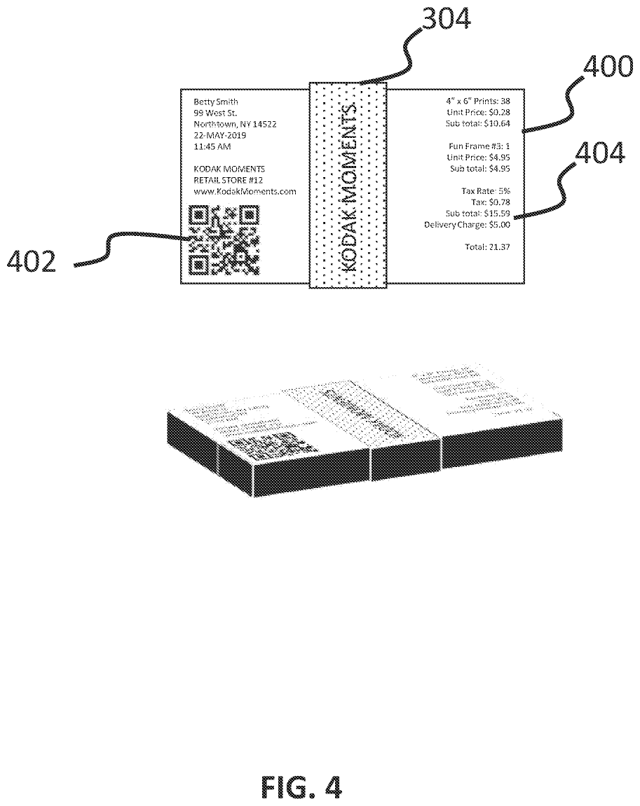

FIG. 4 depicts an embodiment of a completed photo order. The band 304 can hold the order together preventing movement of the photos until the band 304 is broken. The top photo print can be an order summary print 400. This can prevent a BOPIS or personal shopper from viewing the top print of the photo order. The order summary print 400 can include both machine readable 402 and human readable code 404. The code can include information including routing information, delivery information, price information, and customer identification. Alternative packaging options can include envelopes, packages, and/or boxes with an external surface. These packaging options can also include the machine readable 402 and human readable code 404 for order identification.

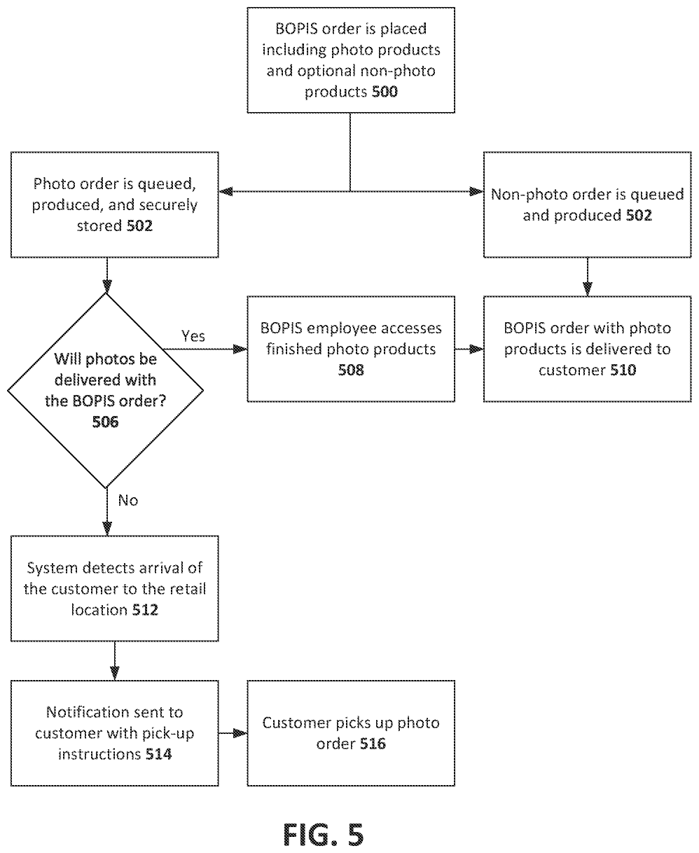

FIG. 5 depicts an embodiment of a method of receiving a photo order as a part of a BOPIS order. The photo order including optional non-photo related products can be placed in step 500. The following steps can be done in parallel. In step 502, the kiosk can queue and produce the photo order. This can be done according to the queuing calculation depicted in FIG. 2. The final photo products can be stored in a secure area such as lockers associated with the kiosk or any other appropriate secured location. The non-photo portion of the order can be queued and produced according to the BOPIS system associated with the retailer in step 504.

For the photo order, the customer can choose to either have the photo order delivered as a part of the BOPIS order or to pickup the order separately in step 506. Separate pickup can be selected for orders with privacy concerns that may not be able to be managed otherwise. This can include larger prints not capable of being banded as shown in FIG. 3 or merchandise which can not be otherwise obscured. If the customer elects to include the photo order with the non-photo products, the photos can be accessed by a BOPIS employee in step 508. This can be done by giving the BOPIS employee an access code to the secured locker or other storage area. Access can be given through the use of a “Clerk App” which can be integrated with the retailer BOPIS system. The order can be delivered through an autonomous photo order dispensing device. The BOPIS employee may scan the machine-readable code as shown in FIG. 4 or otherwise confirm pickup of the photo order.

The complete order can then be delivered to the customer with photo products and non-photo products in step 510. In one embodiment, customers can wait in a designated parking area for curbside delivery. The parking spots within the designated parking area can be labeled with printed and/or dynamic electronic signs. Alternatively, the customer can receive a notification that their order is ready with directions to proceed to a pick-up window. The retailer can use information on the car's model, color, and/or license plate to identify the customer for delivering the order.

If the customer elects not to have the photo order delivered as a part of a BOPIS order, the system can be configured to allow personal pickup of the order. First, the system can detect the arrival of the customer in step 512. This can be done by detecting when the customer enters a geofence around the retail location. The system can then be configured to notify the customer with pick-up instructions for the photo order in step 514. This can include instructions with kiosk location, storage locker number, and passcode for accessing the locker. This can also include dynamic signage at the pick-up location which can include estimated completion times, amount due, promotions, and ads while the customer waits. The dynamic electronic signs within a designated parking area can also be configured with this information. The customer can then pickup the photo product in step 516. The order can be delivered through an autonomous photo order dispensing device. This device can be used for at store, inside of store, curbside delivery, and drive through order pickup. In orders with non-photo purchases, the non-photo order can be delivered in step 510 during pick-up of the photo order in step 516.

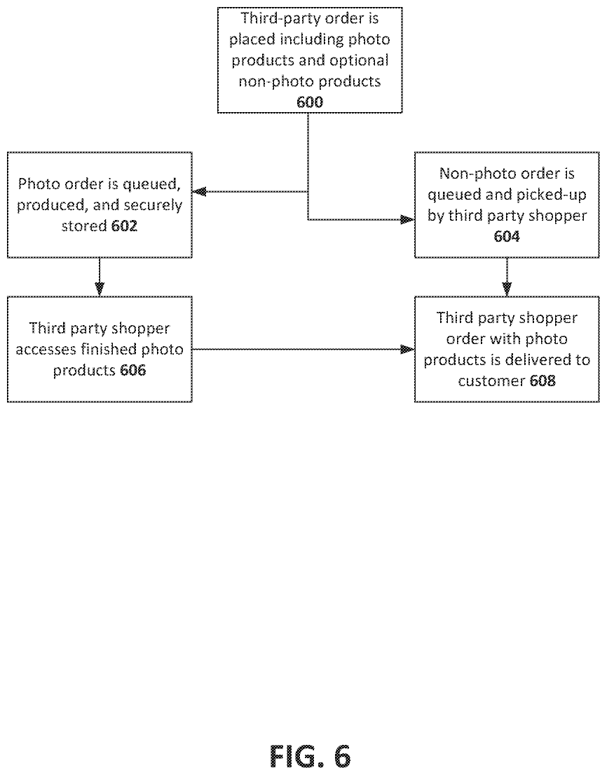

FIG. 6 depicts an embodiment of a method of receiving a photo order as a part of a personal shopper delivery order. This can be similar to the method depicted in FIG. 5 without the option for customer pick-up of the photo order. The order can be placed in step 600 with photo products and non-photo products. The photo order can be queued and produced in step 602 and the non-photo order can be queued and picked up in step 604. While at the retail location, the personal shopper can access and pick-up the photo order at the kiosk in step 606. This can be done by giving the personal shopper an access code to the secured locker or other storage area. The personal shopper may scan the machine-readable code as shown in FIG. 4 or otherwise confirm pickup of the photo order. The personal shopper can then deliver the completed order in step 608 to the customer.

The invention claimed is:

1. A method of providing photofinishing services to a user, the method comprising:
providing by a processor via a communications network and user interface, choices of photofinishing services, retailers, retail locations, delivery methods, and payment options, wherein the processor is configured to:
provide to the user, via the user interface, the ability to send one or more digital images to a selected retailer and retail location via the communications network;
receive from the user a type and amount of photo products to be made from the digital images, any additional retail products, a delivery means, and a payment option;
coordinate the communications for: production of the photofinishing order, billing, and any other retail purchase selected by the user;
calculate the total billing, communicate the other retail purchase to a retail staff and/or personal shopper, coordinate production of the photofinishing order; and
coordinate delivery and payment of the photofinishing order and the other retail purchases by the user.

2. The method of claim 1, wherein the delivery means include: pickup at store, inside the store pickup, curbside delivery, via a drive through pickup window, home delivery, or to a selected recipient.

3. The method of claim 2, further including notifying the user via a text, email, or phone call with an estimated delivery time and location.

4. The method of claim 1, wherein the photofinishing order is given high priority and a target completion time is established to accommodate perishable retail products.

5. The method of claim 1, wherein a retail staff, personal shopper, photo kiosk provider, or third-party service provider performs one or more actions selected from the group consisting of: media resupply, routine service, error correction, software updates, product updates, and promotional updates for the photo kiosk system.

6. The method of claim 1, wherein photofinishing services comprise:
production of photo prints, photo products, framed photographs, photo albums, photo mugs, photo apparel, or virtual photo products stored on portable memory device or delivered via a network.

7. The method of claim 1, wherein the modular photo kiosk system is configurable to accommodate multiple output device and printer types.

8. The method of claim 1, wherein the modular photo kiosk is portable and configured to operate in harsh environments including warehouses, loading docks, or product marshalling areas.

9. The method of claim 1, wherein a photofinishing billing is charged separately from the additional retail products.

10. The method of claim 1, wherein the photofinishing order is packaged to prevent unauthorized viewing of the printed images or photo products using obscuring envelopes, packages, boxes with an external surface of the package and include printed human and machine-readable order identification information.

11. The method of claim 10, further comprising:
packaging a stack of prints with an obscuring top print that includes the human and machine-readable order identification information that is secured with a paper, plastic, or elastic band.

12. The method of claim 1, wherein the photofinishing order that is sent by the user to the designated retailer and retail location is forwarded to another associated retailer or local photofinishing hub for production.

13. The method of claim 1, wherein the modular photo kiosk comprises an integrated internet connection such as cellular network access and accesses the internet by connecting to a retailer's network connection.

14. The method of claim 12, wherein a packaging means is integrated into the photo kiosk.

15. The method of claim 14, further comprising:
forwarding photo product orders that required additional finishing steps to the local photofinishing hub for production.

16. The method of claim 1, wherein the graphic user interface is provided as a chatbot.

17. The method of claim 2, further comprising:
generating a geofence surrounding the designated curbside delivery parking lot location to alert the retailer of an arrival and identity of the user.

18. The method of claim 2, wherein an autonomous photo order dispensing device is used for pickup at store, inside the store, curbside delivery, or via a drive through pickup window.

19. The method of claim 2, further comprising using a user's phone to provide order and payment confirmation.

20. The method of claim 2, further comprising providing home delivery via an autonomous or remotely piloted delivery drone.
